(19) United States
(12) Patent Application Publication
(10) Pub. No.: US 2012/0306404 A1
(43) Pub. Date: Dec. 6, 2012

(54) LED DRIVER CIRCUIT

(75) Inventors: Yuan-Hung Lo, Taipei (TW); Yen-Hui Wang, Taipei (TW); Wei-Chuan Su, Taipei City (TW)

(73) Assignee: IMMENSE ADVANCE TECHNOLOGY CORP., Taipei (TW)

(21) Appl. No.: 13/152,116

(22) Filed: Jun. 2, 2011

(51) Int. Cl. H05B 37/02

(52) U.S. Cl. 315/291

(57) ABSTRACT

An LED driver circuit, including: an LED load, having a top end, a middle end, and a bottom end, wherein the top end is coupled to a line voltage; and a variable load device, having a first input end, a second input end, and an output end, wherein the first input end is coupled to the middle end of the LED load for receiving a first current, the second input end is coupled to the bottom end of the LED load for receiving a second current, and the output end is for providing an output current, which equals the sum of the first current and the second current, and wherein the first current increases/decreases as the second current decreases/increases.

### BACKGROUND OF THE INVENTION

1. Field of the Invention

The present invention relates to a LED driver circuit, and more particularly to a LED driver circuit capable of adjusting the resistance of a LED load in response to variation of a line voltage.

2. Description of the Related Art

Please refer to FIG. 1, which illustrates a prior art LED driver circuit. As illustrated in FIG. 1, the prior art LED driver circuit includes a bridge rectifier 110, an amplifier 120, a current sensing resistor 130, an NMOS transistor 140, and a LED load 150.

The bridge rectifier 110 is used for rectifying an AC power V_{AC} to generate a line voltage V_{LINE}.

The amplifier 120 is used for amplifying the difference of a reference voltage V_{REF} and a feedback signal V_{FB} to generate a gate signal V_{G}, wherein the reference voltage V_{REF} is a DC voltage.

The current sensing resistor 130 is used for generating the feedback signal V_{FB} in response to an output current I_{O}.

The NMOS transistor 140 is used for controlling the output current I_{O} in response to the gate signal V_{G}—the higher the gate signal V_{G}, the larger the output current I_{O}.

The LED load 150, powered by the line voltage V_{LINE}, emits light according to the output current I_{O}—the larger the output current I_{O}, the higher the light intensity.

When in operation, the feedback signal V_{FB} will be regulated at the reference voltage V_{REF} due to negative feedback mechanism of this circuit, and the drain-source voltage V_{DS} of the NMOS transistor 140 will vary with the line voltage V_{LINE} in a way that the output current I_{O} is kept constant. However, when the line voltage V_{LINE} is changed from the lowest level to the highest level of the allowed range—for example, the allowed range is 85V-135V, and the line voltage V_{LINE} is changed from 85V to 135 V—of the prior art LED driver circuit, then the drain-source voltage V_{DS} of the NMOS transistor 140 will increase by 50V, degrading the efficiency of power converted from the line voltage V_{LINE} to the LED load 150, and a large amount of heat will be generated thereby.

In view of the foregoing problems, the present invention proposes a novel LED driver circuit, which is capable of adjusting the resistance of the LED load in response to variation of the line voltage.

### SUMMARY OF THE INVENTION

The major objective of the present invention is to propose a LED driver circuit capable of adjusting the resistance of a LED load in response to a line voltage.

Another objective of the present invention is to propose a LED driver circuit capable of offering a regulated output current with high efficiency irrespective of the level of a line voltage.

Still another objective of the present invention is to propose a LED driver circuit capable of offering a regulated output current with low heat dissipation in a power transistor irrespective of the level of a line voltage.

To achieve the foregoing objectives of the present invention, a LED driver circuit is proposed, the LED driver circuit including:

a LED load, having a top end, a middle end, and a bottom end, wherein the top end is coupled to a line voltage; and

a variable load device, having a first input end, a second input end, and an output end, wherein the first input end is coupled to the middle end of the LED load for receiving a first current, the second input end is coupled to the bottom end of the LED load for receiving a second current, and the output end is for providing an output current, which equals the sum of the first current and the second current, and wherein the first current will decrease/increase to keep the output current regulated when the second current is caused to increase/decrease by a higher/lower level of the line voltage.

Preferably, the line voltage is generated by a bridge rectifier rectifying an AC power.

In a preferred embodiment, the variable load device includes:

a transistor, having a top terminal, a control terminal, and a bottom terminal, wherein the top terminal is coupled to the first input end for receiving the first current; the control terminal is coupled to a gate voltage, and the bottom terminal, for delivering the first current, is coupled to the second input end;

a current sensing resistor, for transforming the output current to a feedback voltage; and

an amplifier, for amplifying the difference of a reference voltage and the feedback voltage to generate the gate voltage.

In another preferred embodiment, the variable load device includes:

a first transistor, having a first top terminal, a first control terminal, and a first bottom terminal, wherein the first top terminal is coupled to the first input end for receiving the first current; the first control terminal is coupled to a bias voltage, and the first bottom terminal, for delivering the first current, is coupled to the second input end;

a second transistor, having a second top terminal, a second control terminal, and a second bottom terminal, wherein the second top terminal is coupled to the first bottom terminal for receiving the output current; the second control terminal is coupled to a gate voltage, and the second bottom terminal is used for delivering the output current;

a current sensing resistor, for transforming the output current to a feedback voltage; and

an amplifier, for amplifying the difference of a reference voltage and the feedback voltage to generate the gate voltage.

To achieve the foregoing objectives of the present invention, another LED driver circuit is proposed, the LED driver circuit including:

a LED load, having a top end, a plurality of middle ends, and a bottom end, wherein the top end is coupled to a line voltage—preferably generated by a bridge rectifier rectifying an AC power, and the bottom end is coupled to a ground;

a connection circuit, having a control end coupled to a control voltage, and a plurality of connecting ends coupled to the middle ends for adjusting the resistance of the LED load according to the control voltage; and

a voltage divider, having a top end coupled to the line voltage, a middle end for providing the control voltage, and a bottom end coupled to the ground.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a prior art LED driver circuit.

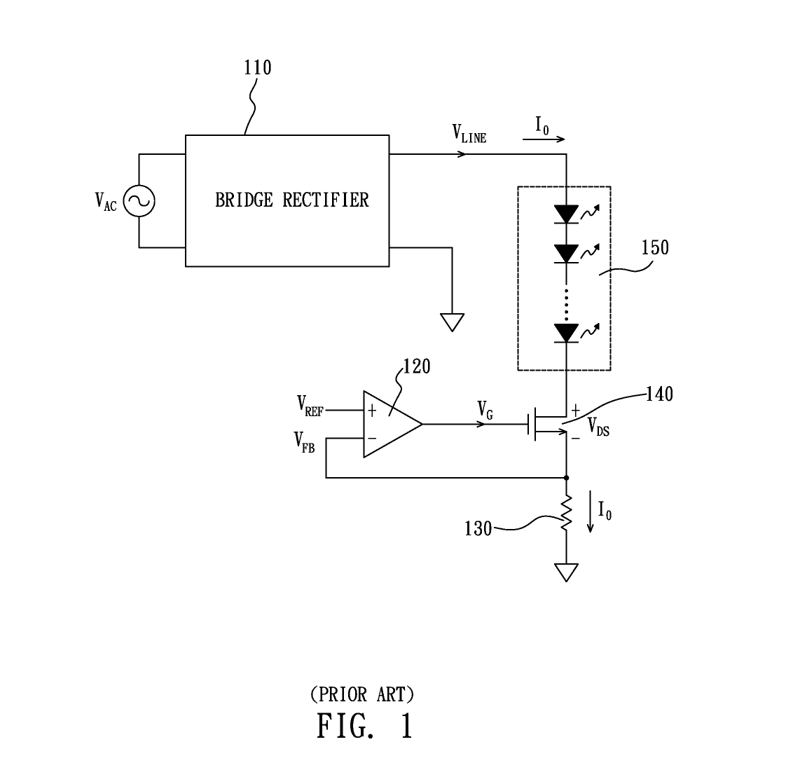

FIG. 2 illustrates a LED driver circuit according to a preferred embodiment of the present invention.

FIG. 3 illustrates the LED driver circuit of FIG.2 with the variable load device implemented by a preferred circuit of negative feedback architecture.

FIG. 4 illustrates the LED driver circuit of FIG.2 with the variable load device implemented by another preferred circuit of negative feedback architecture.

FIG. 5 illustrates the LED driver circuit of FIG.2 with the variable load device implemented by still another preferred circuit of negative feedback architecture.

FIG. 6 illustrates the LED driver circuit of FIG.2 with the variable load device implemented by still another preferred circuit of negative feedback architecture.

FIG. 7 illustrates a LED driver circuit according to another preferred embodiment of the present invention.

FIG. 8 illustrates an efficiency figure measured from the circuit of FIG. 5.

### DETAILED DESCRIPTION OF THE PREFERRED EMBODIMENTS

The present invention will be described in more detail hereinafter with reference to the accompanying drawings that show the preferred embodiments of the invention.

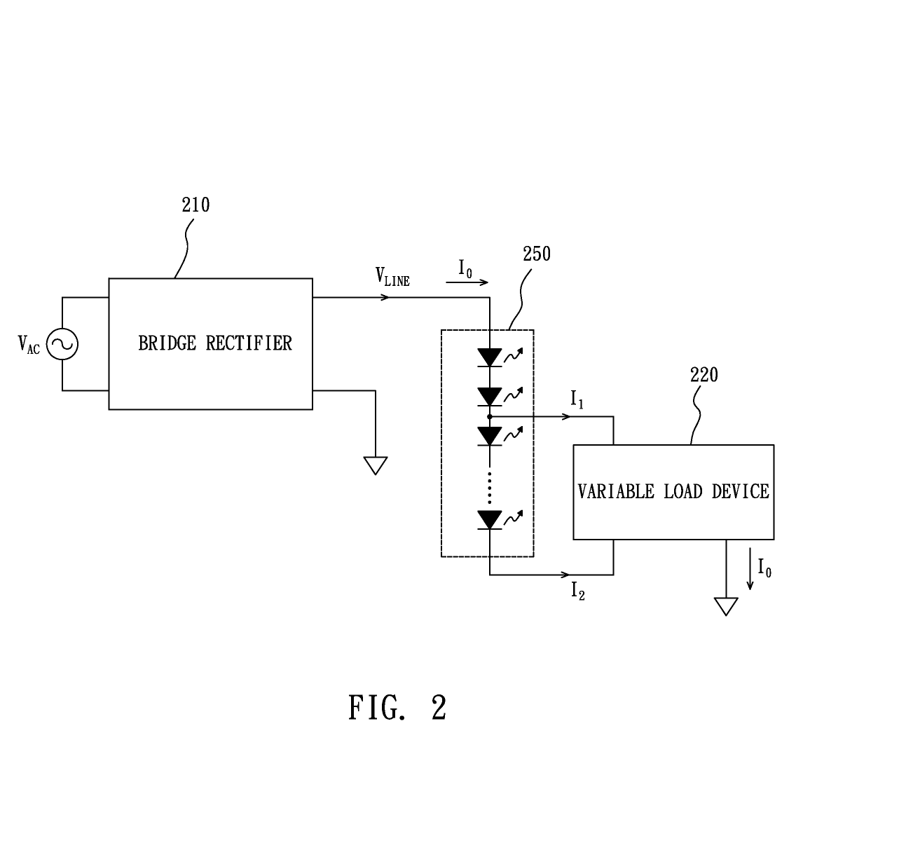

Please refer to FIG. 2, which illustrates a LED driver circuit according to a preferred embodiment of the present invention. As illustrated in FIG. 2, the LED driver circuit includes a bridge rectifier 210, a variable load device 220, and a LED load 250.

The bridge rectifier 210 is used for rectifying an AC power V_{AC} to generate a line voltage V_{LINE}.

The variable load device 220, having a first input end, a second input end, and an output end, wherein the first input end is used for receiving a first current I₁, the second input end is used for receiving a second current I₂, and the output end is for providing an output current I_{O}, which equals the sum of the first current I₁ and the second current I₂. When the second current I₂ is caused to increase/decrease by a higher/lower level of the line voltage V_{LINE}, the variable load device 220 will increase/decrease a channel resistance between the first input end and the second input end to decrease/increase the first current I₁, so as to keep the output current I_{O} regulated.

The LED load 250, having a top end, a middle end, and a bottom end, wherein the top end is coupled to the line voltage V_{LINE}, the middle end is coupled to the first input end of the variable load device 220, and the bottom end is coupled to the second input end of the variable load device 220.

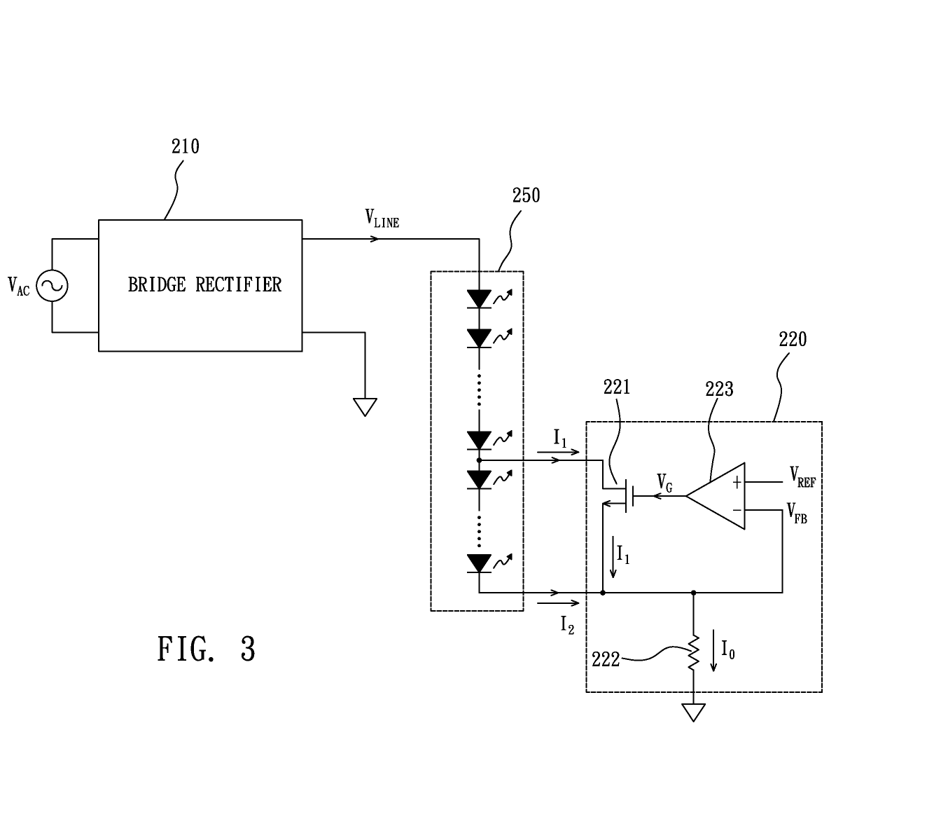

Please refer to FIG. 3, which illustrates the LED driver circuit of FIG.2 with the variable load device 220 implemented by a preferred circuit of negative feedback architecture. As illustrated in FIG. 3, the variable load device 220 includes an NMOS transistor 221, a current sensing resistor 222, and an amplifier 223.

The NMOS transistor 221 has a drain terminal as a top terminal, a gate terminal as a control terminal, and a source terminal as a bottom terminal, wherein the top terminal is coupled to the first input end for receiving the first current I₁; the control terminal is coupled to a gate voltage V_{G}, and the bottom terminal, for delivering the first current I₁, is coupled to the second input end.

The current sensing resistor 222 is used for transforming the output current I_{O} to a feedback voltage V_{FB}.

The amplifier 223 is used for amplifying the difference of a reference voltage V_{REF} and the feedback voltage V_{FB} to generate the gate voltage V_{G}.

When in operation, due to the negative feedback architecture, the feedback voltage V_{FB} will follow the reference voltage V_{REF}, making the output current I_{O} regulated and insensitive to variation of the line voltage V_{LINE}. That is, when the line voltage V_{LINE} becomes higher/lower, the output current I_{O} will initially get larger/smaller. However, due to the negative feedback effect, the gate voltage V_{G} will become lower/higher to decrease/increase the first current I₁, so as to pull the output current I_{O} back to a constant value.

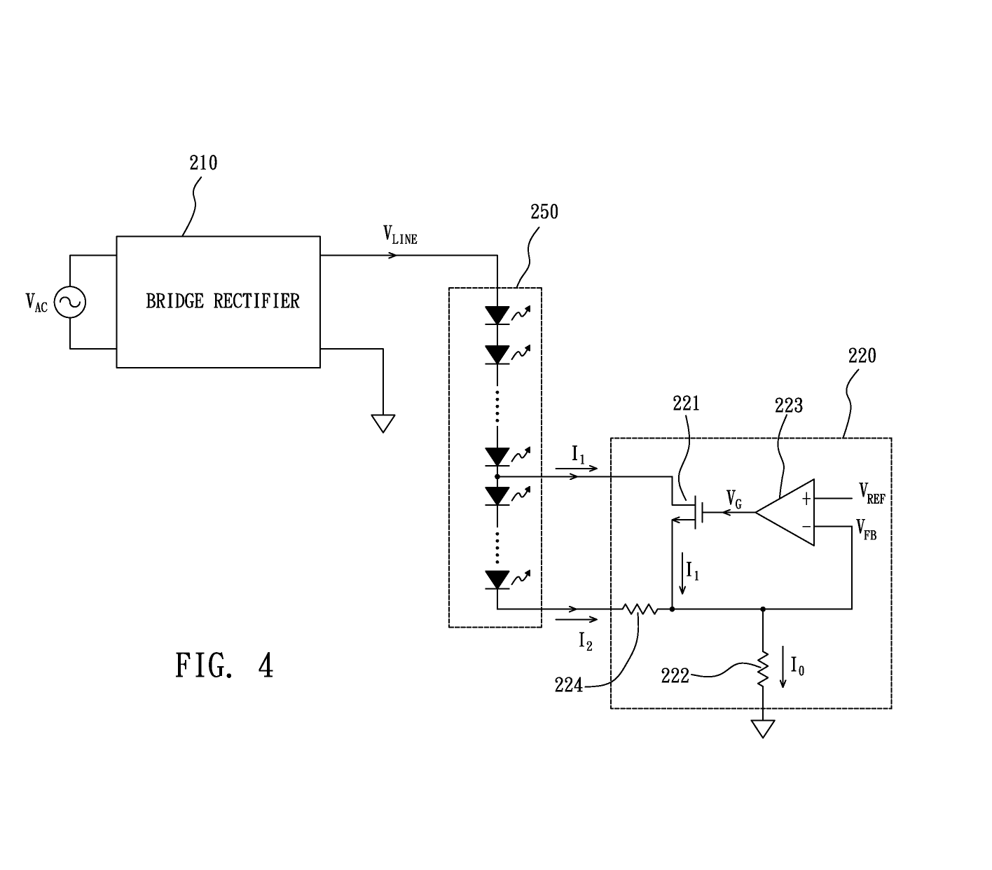

Please refer to FIG. 4, which illustrates the LED driver circuit of FIG.2 with the variable load device implemented by another preferred circuit of negative feedback architecture. As illustrated in FIG. 4, the variable load device 220 includes an NMOS transistor 221, a current sensing resistor 222, an amplifier 223, and a degeneration resistor 224.

As the circuit of FIG. 4 is derived from that of FIG. 3 by adding in the degeneration resistor 224, the specification of FIG. 4 will focus on the degeneration resistor 224. The degeneration resistor 224 is used for broadening the linear operation range of the variable load device 220 to allow wider range of the line voltage V_{LINE}.

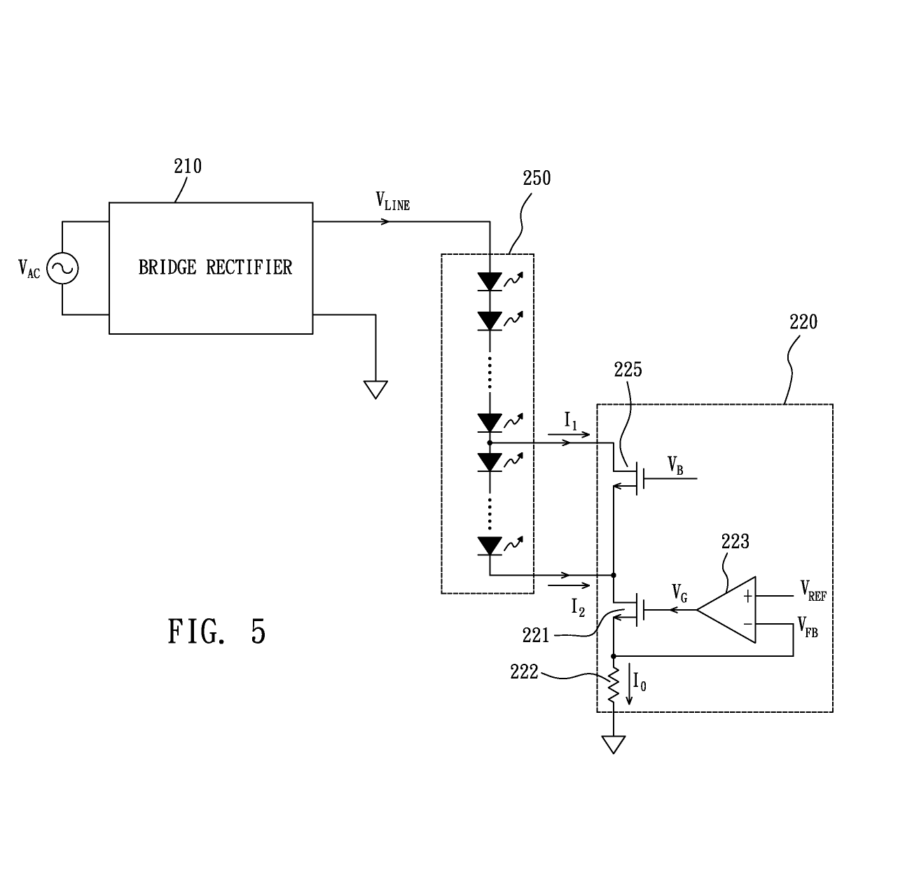

Please refer to FIG. 5, which illustrates the LED driver circuit of FIG.2 with the variable load device 220 implemented by still another preferred circuit of negative feedback architecture. As illustrated in FIG. 5, the variable load device 220 includes a second NMOS transistor 221, a current sensing resistor 222, an amplifier 223, and a first NMOS transistor 225.

The second NMOS transistor 221 has a drain terminal as a second top terminal, a gate terminal as a second control terminal, and a source terminal as a second bottom terminal, wherein the second top terminal is coupled to the second input end and the first NMOS transistor 225 for receiving the output current I_{O}; the second control terminal is coupled to a gate voltage V_{G}, and the second bottom terminal is used for delivering the output current I_{O}.

The current sensing resistor 222 is used for transforming the output current I_{O} to a feedback voltage V_{FB}.

The amplifier 223 is used for amplifying the difference of a reference voltage V_{REF} and the feedback voltage V_{FB} to generate the gate voltage V_{G}.

The first NMOS transistor 225 has a drain terminal as a first top terminal, a gate terminal as a first control terminal, and a source terminal as a first bottom terminal, wherein the first top terminal is coupled to the first input end for receiving the first current I₁; the first control terminal is coupled to a bias voltage V_{B}, and the first bottom terminal, for delivering the first current I₁, is coupled to the second top terminal of the second NMOS transistor 221 and the second input end.

When in operation, due to the negative feedback architecture, the feedback voltage V_{FB} will follow the reference voltage V_{REF}, making the output current I_{O} regulated and insensitive to variation of the line voltage V_{LINE}. That is, when the line voltage V_{LINE} becomes higher/lower, the output current I_{O} will initially get larger/smaller. However, due to the negative feedback effect, the gate voltage V_{G} will become lower/higher to make the source voltage of the first NMOS transistor 225 to shift higher/lower and therefore causing the gate-source voltage of the first NMOS transistor 225 to decrease/increase. As a result, the first current I₁ will decrease/increase to pull the output current I_{O} back to a constant value.

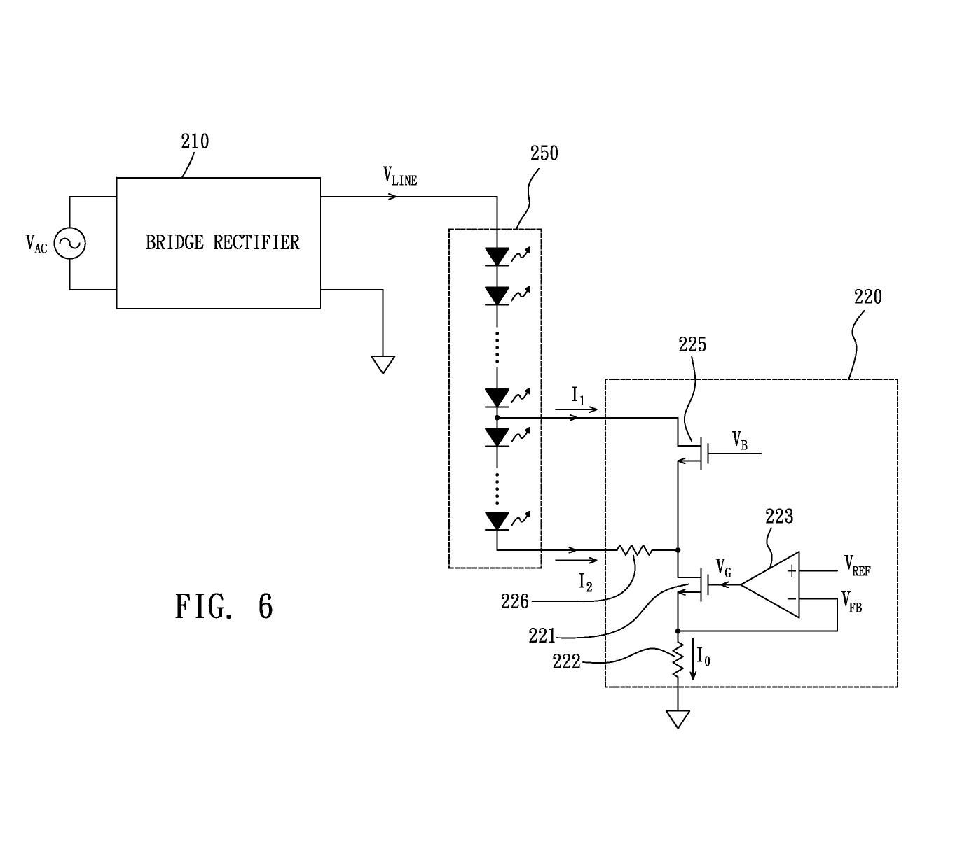

Please refer to FIG. 6, which illustrates the LED driver circuit of FIG.2 with the variable load device implemented by still another preferred circuit of negative feedback architecture. As illustrated in FIG. 6, the variable load device 220 includes a second NMOS transistor 221, a current sensing resistor 222, an amplifier 223, a first NMOS transistor 225, and a degeneration resistor 226.

As the circuit of FIG. 6 is derived from that of FIG. 5 by adding in the degeneration resistor 226, the specification of FIG. 6 will focus on the degeneration resistor 226. The degeneration resistor 226 is used for broadening the linear operation range of the variable load device 220 to allow wider range of the line voltage V_{LINE}.

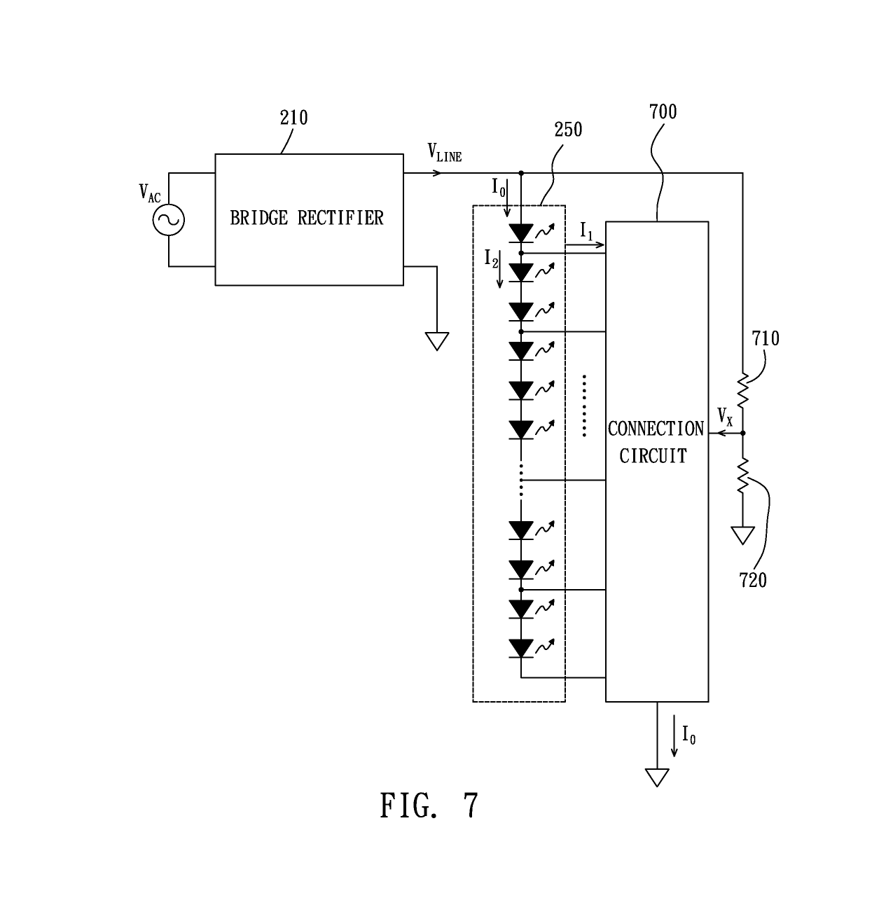

Please refer to FIG. 7, which illustrates a LED driver circuit according to another preferred embodiment of the present invention. As illustrated in FIG. 7, the LED driver circuit includes a bridge rectifier 210, a LED load 250, a connection circuit 700, a resistor 710, and a resistor 720.

The bridge rectifier 210 is used for rectifying an AC power V_{AC} to generate a line voltage V_{LINE}.

The LED load 250 has a top end, a plurality of middle ends, and a bottom end, wherein the top end is coupled to the line voltage V_{LINE} for receiving a resulted current I_{O}, which is divided into I₁ and I₂ at the top one of the middle ends, and the bottom end is coupled to the connection circuit 700.

The connection circuit 700 has a control end coupled to a control voltage V_{X}, and a plurality of connecting ends—dividing the connection circuit 700 into a plurality of sectors—coupled to the middle ends for adjusting the resistance of the LED load 250 according to the control voltage V_{X}.

The resistor 710 and the resistor 720 act as a voltage divider, having a top end coupled to the line voltage V_{LINE}, a middle end for providing the control voltage V_{X}, and a bottom end coupled to the ground.

When in operation, the connection circuit 700 will increase/decrease the resistance of the sectors to decrease/increase the current flowing into the connection circuit 700—for example I₁—as the control voltage V_{X} gets higher/lower, so as to keep I_{O} regulated.

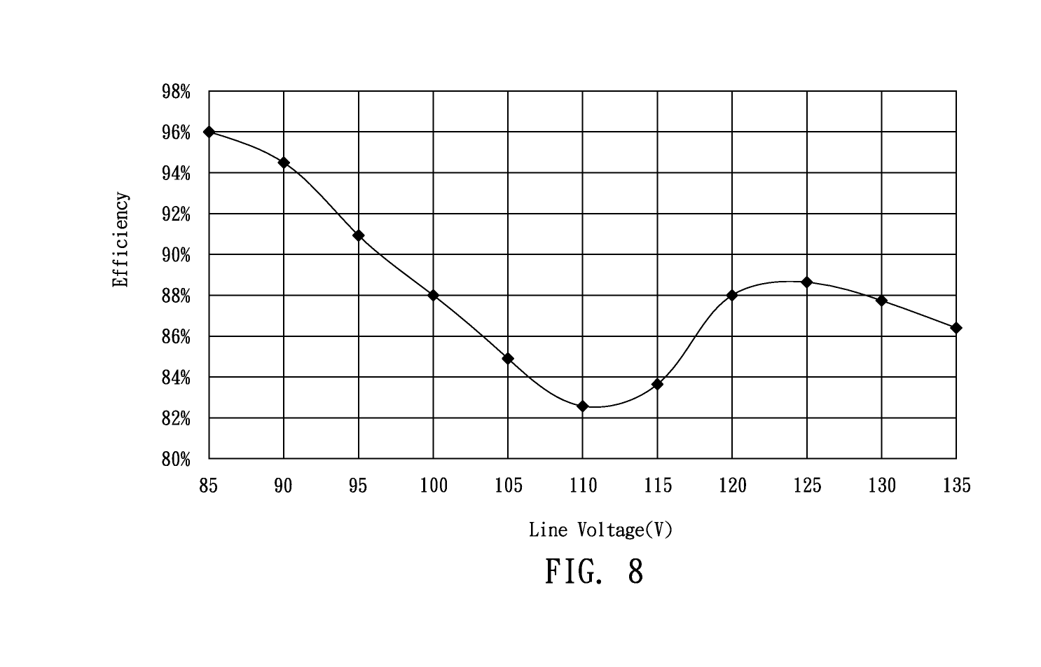

In conclusion, the LED driver circuit of the present invention is capable of adjusting the resistance of a LED load in response to a line voltage, so as to offer a regulated output current with high efficiency and with low heat dissipation in a power transistor irrespective of the level of a line voltage. Please refer to FIG. 8, which illustrates an efficiency figure measured from the circuit of FIG. 5. As can be seen in FIG. 8, the efficiency (the ratio of the power dissipated in the LED load to the power delivered from the line voltage V_{LINE}) is ranging from 82% to 96%, much better than those of prior art LED driver circuits. Therefore, the present invention does improve the prior art LED driver circuits.

While the invention has been described by way of example and in terms of preferred embodiments, it is to be understood that the invention is not limited thereto. To the contrary, it is intended to cover various modifications and similar arrangements and procedures—for example, the transistor 221 or the transistor 225 can be one selected from the group consisting of NMOS transistor, PMOS transistor, bipolar junction transistor, and combination thereof, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An LED driver circuit, comprising:
an LED load, having a top end, a middle end, and a bottom end, wherein said top end is coupled to a line voltage; and
a variable load device, having a first input end, a second input end, and an output end, wherein said first input end is coupled to said middle end of said LED load for receiving a first current, said second input end is coupled to said bottom end of said LED load for receiving a second current, and said output end is for providing an output current, which equals the sum of said first current and said second current, and wherein said first current increases/decreases as said second current decreases/increases.

2. The LED driver circuit as claim 1, further comprising a bridge rectifier for rectifying an AC power to generate said line voltage.

3. The LED driver circuit as claim 1, wherein said variable load device comprises:
a transistor, having a top terminal, a control terminal, and a bottom terminal, wherein said top terminal is coupled to said first input end for receiving said first current; said control terminal is coupled to a gate voltage, and said bottom terminal, for delivering said first current, is coupled to said second input end;
a current sensing resistor, for transforming said output current to a feedback voltage; and
an amplifier, for amplifying the difference of a reference voltage and said feedback voltage to generate said gate voltage.

4. The LED driver circuit as claim 1, wherein said variable load device comprises:
a transistor, having a top terminal, a control terminal, and a bottom terminal, wherein said top terminal is coupled to said first input end for receiving said first current; said control terminal is coupled to a gate voltage, and said bottom terminal, for delivering said first current, is coupled to said second input end through a resistor;
a current sensing resistor, for transforming said output current to a feedback voltage; and
an amplifier, for amplifying the difference of a reference voltage and said feedback voltage to generate said gate voltage.

5. The LED driver circuit as claim 1, wherein said variable load device comprises:
a first transistor, having a first top terminal, a first control terminal, and a first bottom terminal, wherein the first top terminal is coupled to said first input end for receiving said first current; said first control terminal is coupled to a bias voltage, and said first bottom terminal, for delivering said first current, is coupled to said second input end;
a second transistor, having a second top terminal, a second control terminal, and a second bottom terminal, wherein said second top terminal is coupled to said second input end and said first bottom terminal for receiving said output current; said second control terminal is coupled to a gate voltage, and said second bottom terminal is used for delivering said output current;
a current sensing resistor, for transforming said output current to a feedback voltage; and
an amplifier, for amplifying the difference of a reference voltage and said feedback voltage to generate said gate voltage.

6. The LED driver circuit as claim 1, wherein said variable load device comprises:
a first transistor, having a first top terminal, a first control terminal, and a first bottom terminal, wherein the first top terminal is coupled to said first input end for receiving said first current; said first control terminal is coupled to a bias voltage, and said first bottom terminal, for delivering said first current, is coupled to said second input end through a resistor;
a second transistor, having a second top terminal, a second control terminal, and a second bottom terminal, wherein said second top terminal is coupled to said first bottom terminal for receiving said output current; said second control terminal is coupled to a gate voltage, and said second bottom terminal is used for delivering said output current;
a current sensing resistor, for transforming said output current to a feedback voltage; and
an amplifier, for amplifying the difference of a reference voltage and said feedback voltage to generate said gate voltage.

7. A LED driver circuit, comprising:
a LED load, having a top end, a plurality of middle ends, and a bottom end, wherein said top end is coupled to a line voltage, and said bottom end is coupled to a ground;
a connection circuit, having a control end coupled to a control voltage, and a plurality of connecting ends coupled to said middle ends for adjusting the resistance of said LED load according to said control voltage; and
a voltage divider, having a top end coupled to said line voltage, a middle end for providing said control voltage, and a bottom end coupled to said ground.

8. The LED driver circuit as claim 7, further comprising a bridge rectifier for rectifying an AC power to generate said line voltage.
